(19) United States
(12) Patent Application Publication
(10) Pub. No.: US 2001/0018366 A1
(43) Pub. Date: Aug. 30, 2001

(54) Game machine, image display method, and recording medium

(76) Inventors: Satoshi Shimomura, Tokyo (JP); Nobuhiro Yamada, Hannou-shi (JP)

Correspondence Address: SUGHRUE, MION, ZINN, MACPEAK & SEAS, PLLC, 2100 Pennsylvania Avenue, N. W., Washington, DC, 20037-3202, US

(21) Appl. No.: 09/748,023

(22) Filed: Dec. 27, 2000

(30) Foreign Application Priority Data
Dec. 28, 1999 (JP) 374320/1999
Mar. 3, 2000 (JP) 58298/2000

(51) Int. Cl. G06F 19/00

(52) U.S. Cl. 463/43

(57) ABSTRACT

In a game machine, a card game is performed by displaying a plurality of cards/characters on a display device. In this game machine, an image of each card/character is divided into a plurality of partial images, and the divided partial images are stored. The partial images are then combined to create a composite card. An image creating method used in the above type of game machine and a recording medium storing a program implementing the image creating method are also be provided. Accordingly, a greater number of cards can be obtained than the original number of cards. Thus, many cards/characters can be displayed with a small memory capacity. Additionally, data concerning the partial images, such as the attacking ability indices and the defending ability indices, are determined by computations, thereby reducing the storage capacity required for storing such data.

### BACKGROUND OF THE INVENTION

1. Field of the Invention

The present invention relates to a game machine, a recording medium used in the game machine, and an image display method for displaying cards, characters, etc., on a screen.

2. Description of the Related Art

Typically, in this type of game machine, a game is performed by controlling the display of a screen according to a player's instruction. Games to be played in such a game machine may be simulation games, role-playing games, fighting games, puzzle games, and so on. Another example of such games is a card game in which a player competes against an opponent by entering or placing cards into predetermined positions on the screen.

Various types of known card games have been proposed, and the assignee of this application has previously brought a card game to market. The card game sold by the assignee can be enjoyed by not only game enthusiasts, but also ordinary people who do not know the rules or children, and this card game has become popular widely. The assignee of the present application previously filed Japanese Patent Application Nos. 11-74598 (re-filed as Japanese Patent Application No. 2000-28066 and not yet published) and 11-74631 (published as Japanese Unexamined Patent Publication (JP-A) No. 2000-157744) to disclose a game machine and a recording medium used for playing the above card game. By utilizing the game machine and the recording medium disclosed in the above applications, a single player is able to solely enjoy a card game by competing against a computer, or two or more players can also play against each other by using a communication function.

In either mode of the above-described game machine, the player is able to visually identify the player's cards placed face down, without being recognized by the opponent. Conversely, the player is unable to know the opponent's card before a battle or duel is started. This serves to make the card game highly interesting like a usual card game.

As cards used in this type of card game, 700 types or species of cards, each type having about 250 cards, i.e., a total of about 175000 cards, are prepared. These cards are grouped into some types, such as monster cards for duels, field cards for determining the duel field, and magic cards which exert specific effects when they are placed into the playing field. The monster cards are further divided into groups and families, to which superiority and inferiority are previously assigned. Under the circumstances, decision is made in the card game about which groups and families are superior to others.

Even with the 700 types of cards, users become used to this card game and may find it too easy to play and, as a result, may quickly lose interest. One of the measures to keep user's interest and attract ordinary people who are not game enthusiasts is to considerably increase the number of species of cards, even by two or three times.

It is, however, very difficult to remarkably increase the number of species of cards within a limited memory space of, for example, a game machine. Particularly in a portable game machine, an increase in the species of usable cards is no longer expected due to a limited memory capacity. The same applies to other games to be played by using many characters.

### SUMMARY OF THE INVENTION

Accordingly, it is an object of the present invention to provide a game machine in which the types of characters, such as cards, can be dramatically increased.

It is another object of the present invention to provide an image display method in which the number of cards can be increased without increasing a memory capacity.

It is still another object of the present invention to provide a recording medium for storing a program implementing the above-described image display method.

In order to achieve the above object, according to one aspect of the present invention, there is provided a game machine for performing a card game by displaying a plurality of cards on a screen of a display device. The game machine includes a storage unit for storing partial images obtained by dividing an image of each of the plurality of cards used in the card game, and a combining unit for combining the partial images so as to create a composite card having an image different from the images of the plurality of cards.

With this arrangement, by combining the partial images, many cards can be created with a small capacity memory.

The aforementioned game machine may further include a sending unit for selectively sending the above-described partial images and composite images, and a receiving unit for receiving the partial images and composite images. It is thus possible to exchange partial images or whole cards with other players.

In the aforementioned game machine, the above-described storage unit stores a table in which an attacking ability index and a defending ability index corresponding to the composite card are stored. By varying the attacking and defending ability indices of the composite card, the entertaining characteristics of the card game can be enhanced.

According to another aspect of the present invention, there is provided an image display method for use in a game machine for performing a card game and for displaying a plurality of cards used in the card game on a screen of a display device. The image display method includes: a storage step of storing partial images obtained by dividing an image of each of the plurality of cards; a combining step of combining the partial images so as to create a composite card having an image different from the images of the plurality of cards; and a display step of displaying the composite card on the display device. The storage step also stores boundary data of each of the partial images. The combining step includes the steps of: including a picture and a background image in one of the partial images and including only a picture of the other partial image and making the partial image other than the picture transparent, and combining the partial images by referring to the boundary data, whereby a greater number of cards is displayed than the number of cards before being divided.

According to this display method, the number of cards which can be displayed can be dramatically increased with a minimal memory capacity. In this manner, a card having a static image can be partially divided so as to create a new card, thereby performing the extensible card game.

According to still another aspect of the present invention, there is provided a computer-readable recording medium for storing a program executing a card game by displaying cards of a player and an opponent on a screen of a display device. The program includes a reading step of reading stored partial images obtained by dividing an image of each of the cards, and a combining step of combining the partial images read in the reading step so as to create a composite card having an image different from the images of the cards.

In this recording medium, many cards can be displayed, and the memory capacity for storing many cards can be minimized. Accordingly, even in a portable game machine with a limited memory capacity, a card game having many types of cards can be played.

According to a further aspect of the present invention, there is provided a computer-readable recording medium for storing a program executing a card game by displaying cards of a player and an opponent on a screen of a display device. The program includes a reading step of reading images of the cards used in the card game, and a computing step of computing data related to each of the cards by using data unique to each of the card.

In this case, the above-described data to be computed may be obtained only for the cards to be combined.

According to a still further aspect of the present invention, there is provided a computer-readable recording medium for storing a program executing a card game by displaying a plurality of cards of a player and an opponent on a screen of a display device. The program includes a reading step of reading stored partial images obtained by dividing an image of each of the plurality of cards, a combining step of combining the partial images read in the reading step so as to create a composite card having an image different from the images of the plurality of cards, and a computing step of computing data related to the composite card created in the combining step.

According to a further aspect of the present invention, there is provided a game machine for performing a card game by displaying cards on a screen of a display device. The game machine includes a storage unit for storing images of the cards used in the card game, and a computation unit for computing data related to the cards other than the images of the cards by using data unique to the cards.

By determining the card-related data by computations, the storage capacity required for storing such card-related data can be considerably reduced.

### BRIEF DESCRIPTION OF THE DRAWINGS

FIG. 1A illustrates a game mode in which a single player plays a card game by using a portable game machine according to the present invention;

FIG. 1B illustrates a game mode in which two players play the card game by connecting the corresponding portable game machines according to the present invention via a communication cable;

FIG. 2 is a block diagram illustrating the internal configuration of a cassette loaded in the portable game machine shown in FIGS. 1A and 1B;

FIG. 3 is a block diagram illustrating the internal configuration of the portable game machine shown in FIG. 1;

FIG. 4 is a block diagram illustrating the specific configuration of a card-image storage area shown in FIG. 2;

FIG. 5 illustrates one example of a card to be created according to the present invention;

FIG. 6 illustrates another example of a card to be created according to the present invention which partially overlaps with the card shown in FIG. 5;

FIG. 7 illustrates still another example of a card to be created according to the present invention which partially overlaps with the card shown in FIG. 5;

FIG. 8 illustrates another example of cards to be created according to the present invention which partially overlaps with the card shown in FIG. 6;

FIG. 9 illustrates a partial image forming the lower parts of the cards shown in FIGS. 5 and 7;

FIG. 10 illustrates a partial image forming the lower part of the cards shown in FIGS. 6 and 8;

FIG. 11 illustrates a partial image forming the upper parts of the cards shown in FIGS. 5 and 6;

FIG. 12 is a flow chart illustrating the card combining process for obtaining the cards shown in FIGS. 5 through 8 according to an embodiment of the present invention;

FIG. 13 is a flow chart illustrating the card sending method according to the present invention;

FIG. 14 is a flow chart illustrating the card combining process according to another embodiment of the present invention;

FIG. 15 is a flow chart illustrating details of one step shown in FIG. 14; and

FIG. 16 is a block diagram illustrating the hardware configuration for executing the card combining process shown in FIG. 14.

### DESCRIPTION OF THE PREFERRED EMBODIMENTS

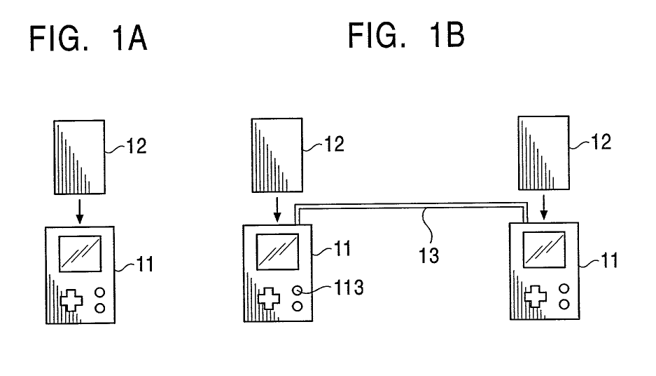

A card game used in the present invention is described below with reference to the drawing attached to the instant specification. In the following description, the game is assumed to be performed by using a commercially available portable game machine 11, as illustrated in FIGS. 1A and 1B. FIG. 1A illustrates a game mode in which a single player enjoys the card game according to the present invention by loading a cassette 12 which stores the card game therein in the portable game machine 11. In this case, the player plays the card game by competing against the portable game machine 11 (or a computer) operated by a program stored in the cassette 12 as a virtual opponent.

FIG. 1B illustrates a game mode in which two players who each own a portable game machine 11 play the game by connecting the two game machines 11 via a communication cable 13. The game machines 11 may also be connected by infrared rays.

As is well known, the portable game machine 11 shown in FIGS. 1A and 1B has a liquid crystal display screen, operation buttons, and selection/setting buttons. In performing the card game, the cassette 12 provided with a recording medium of the present invention which stores the card game program therein is loaded in the portable game machine 11.

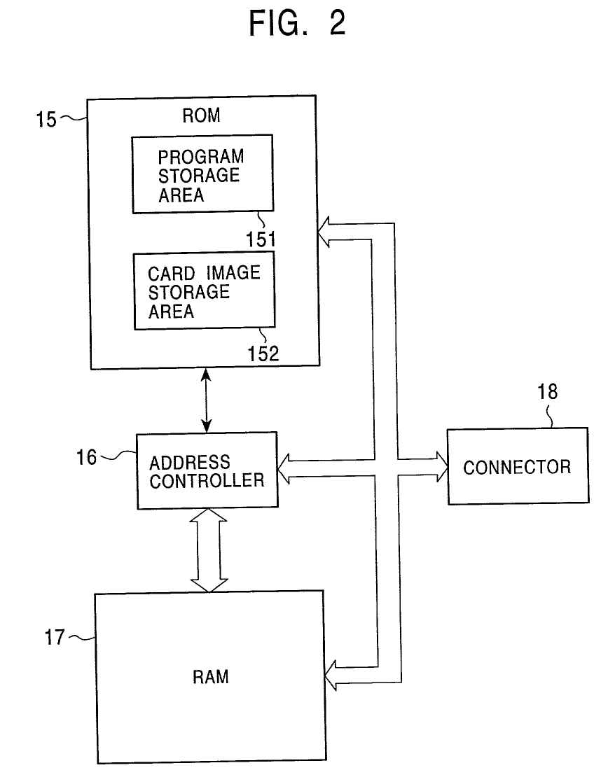

The internal configuration of the cassette 12 used in the present invention is discussed below with reference to FIG. 2. As shown in FIG. 2, the cassette 12 has a read only memory (ROM) 15 formed by a semiconductor memory, an address controller 16 for accessing the ROM 15, a random access memory (RAM) 17 for temporarily storing a game result, and a connector 18 for connecting this cassette 12 to a game machine. Among the above elements, the ROM 15 is operated as a recording medium for storing a program according to the present invention. The ROM 15, the address controller 16, and the RAM 17 are connected with each other via bi-directional buses and are also connected to the connector 18. According to the configuration shown in FIG. 2, the ROM 15, the address controller 16, and the RAM 17 can be individually accessed from the game machine via the connector 18 and the buses.

The ROM 15 includes a program storage area 151 and a card-image storage area 152. The program storage area 151 stores a program for executing the card game used in the present invention, while images of the individual cards are stored in the card-image storage area 152 by using the image display method of the present invention mentioned in detail below. Although only these two storage areas 151 and 152 are shown in FIG. 2, the ROM 15 also stores other areas, such as a background-image storage area for storing background images. However, the background-image storage area is not directly o the present invention, and an explanation thereof is thus omitted for simple description.

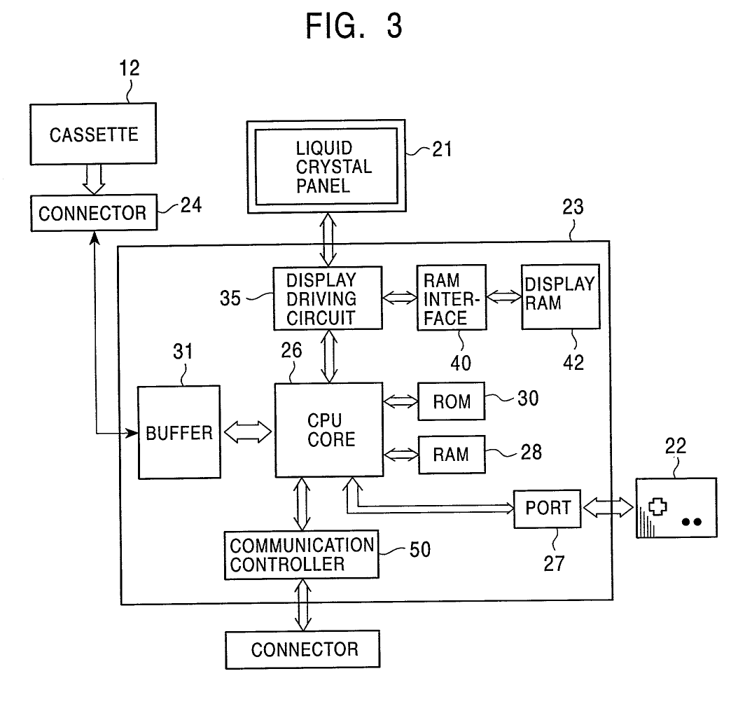

Referring to FIG. 3, a description is given below about the configuration of the portable game machine 11 for performing the game by loading the cassette 12 shown in FIG. 1 in the game machine. As exemplified in Japanese Unexamined Patent Publication No. Hei 2-210562 (namely, 210562/1990), the portable game machine 11 is provided with a liquid crystal panel 21 which forms a display screen, an operation panel 22 on which operation buttons and selection/setting buttons are disposed, and a central processing unit (CPU) 23. The cassette 12 that has the recording medium (ROM) 15 shown in FIG. 2 is coupled to the CPU 23 via a connector 24.

The CPU 23 includes a CPU core 26, a port 27 disposed between the CPU core 26 and the operation panel 22, and a random access memory (RAM) 28 and a ROM 30, both of which are connected to the CPU core 26. The CPU core 26 is connected to a buffer 31 used for providing timing, addressing, and data, and is also connected to the connector 24 via a bus. A display driving circuit 35 is connected between the CPU core 26 and the liquid crystal panel 21. The display driving circuit 35 is connected via a display RAM interface 40 to a display RAM 42 which stores characters to be displayed on the liquid crystal panel 21.

In the portable game machine 11, a communication controller 50 which has a communication control interface is connected to the CPU core 26. The communication controller 50 serves to connect the game machine 11 to the counterpart of an opponent via a connector connected to the communication controller 50. The ROM 30 stores an operating system (OS) which controls the liquid crystal panel 21, the display driving circuit 35, the communication controller 50, etc.

The cassette 12 that stores the card game program of the present invention is attached to the CPU core 26 via the connector 24 and, thereafter, the portable game machine 11 is powered on or reset. Then, the CPU core 26 runs the OS stored in the ROM 30 to initialize the entire game machine 11 and also to load the card game program stored in the recording medium 15 into the RAM 28 (operated as a main storage device), and the display RAM 42. In this state, in response to manipulation of the operation panel 22 by the player, the CPU core 26 executes the card game program and also displays required displaying data on the liquid crystal panel 21.

More specifically, the display RAM 42 is accessed through the display RAM interface 40 in response to the display data displayed on the liquid crystal panel 21, so as to read cards, characters, and the like, out of the display RAM 42. The cards, characters, and the like are displayed on the liquid crystal panel 21 via the display driving circuit 35.

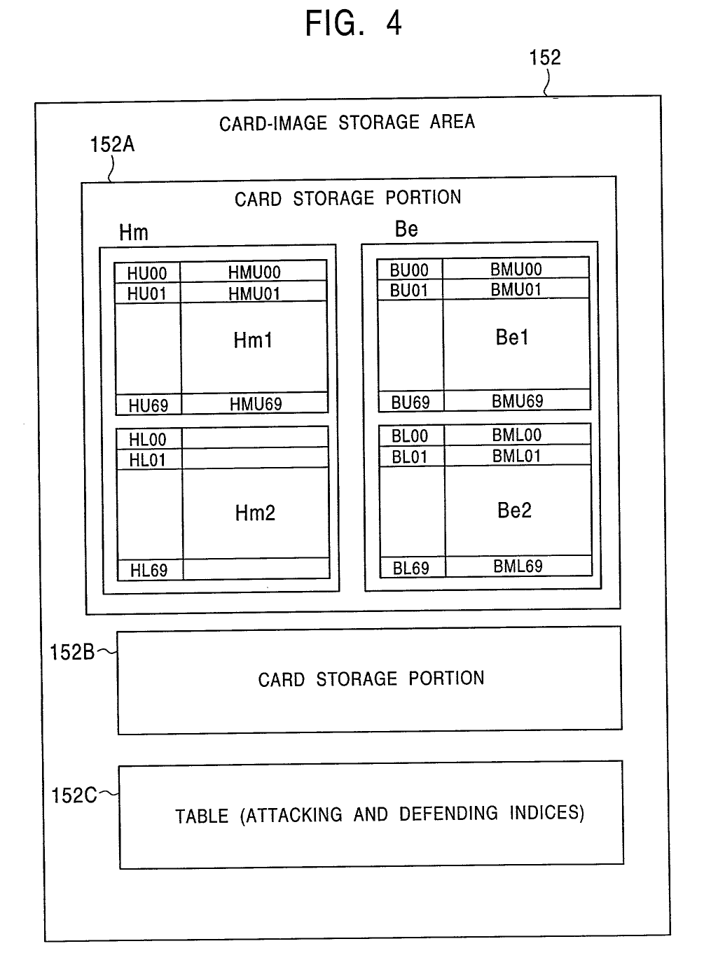

The configuration of the card-image storage area 152 shown in FIG. 2 is more specifically described below with reference to FIG. 4. The card-image storage area 152 contains card storage portions 152A and 152B. The card storage portion 152B stores card images similar to those used in the card game machine disclosed in the before mentioned applications and will not be described any longer. The card-image storage area 152 also stores a table 152C representing attacking ability indices and defending ability indices of the individual cards stored in the card storage portions 152A and 152B. As will be described later, the table 152C also stores the attacking ability index and the defending ability index of each card obtained by combining partial images stored in the card storage portion 152A. In this case, in the table 152C, the attacking ability index and the defending ability index may be stored at each partial image stored in the card storage portion 152A. The attacking ability index and the defending ability index may vary at every field like in the cards stored in the card storage portion 152B.

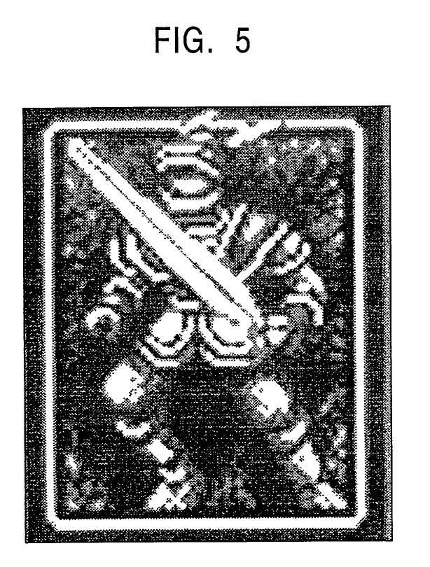

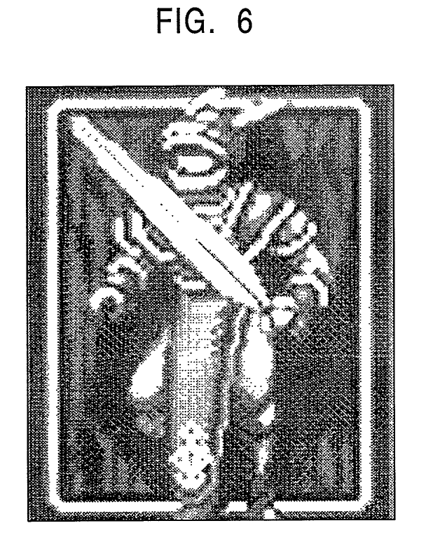

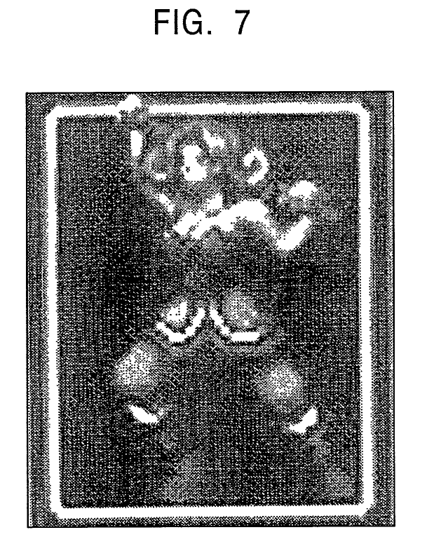

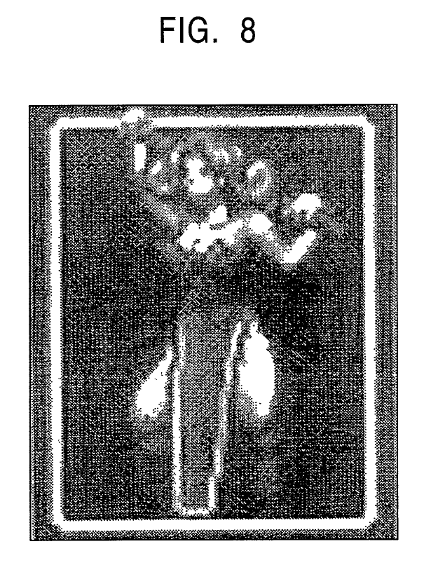

Before describing the configuration of the card storage portion 152A, a method of creating cards used in the present invention is discussed below with reference to FIGS. 5 through 8. Two cards indicating armored fighters with a sword are shown in FIGS. 5 and 6. By comparing these cards, it is readily understood that the image of the upper part of one card is the same as that of the other card. In other words, only the image of the lower part of each card is different from each other. FIGS. 7 and 8 show cards indicating female fighters, and the image of the upper part of one image is the same as that of the other card, namely, only the image of the lower part is different from each other. In FIGS. 5 and 7, it is to be noted that the image of the lower part of the armored fighter is the same as that of the female fighter. In FIGS. 6 and 8, it is found out that the image of the lower part of the armored fighter is the same as that of the female fighter.

Accordingly, in the present invention, each image can be divided into two parts, such as the upper part and the lower part. By combining the two parts, in this example, four card images can be created from two card images, as shown in FIGS. 5 through 8. Although in this example the image of each card is divided into the upper part and the lower part, as shown in FIGS. 5 through 8, it may be divided into the face and the body or into three or more images. In this manner, the position at which an image is divided is not particularly restricted unless a composite image appears unnatural.

According to the above-described card creating method used in the present invention, the number of cards can be doubled with a small memory capacity. However, it is necessary to select the dividing position of each card so that the composite image looks natural, or to prepare the design of each card so that divided images look natural.

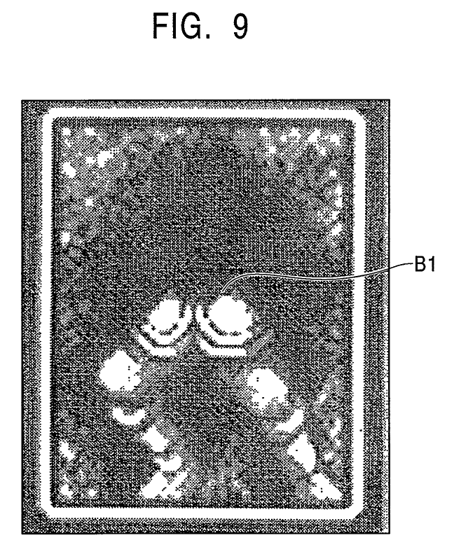

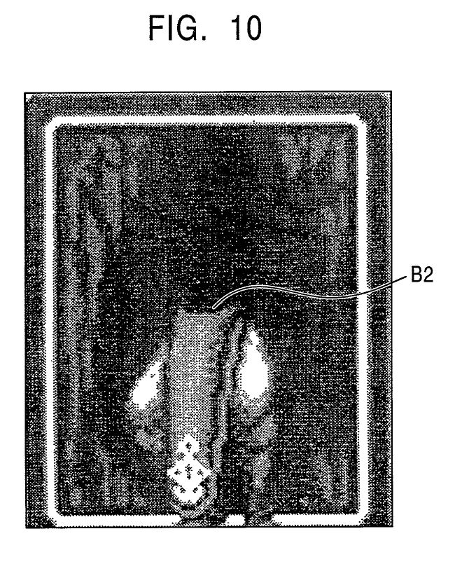

The card creating method is then discussed more in detail, by way of example, about the cards shown in FIGS. 5 through 8. As illustrated in FIG. 9, a lower part image corresponding to the lower parts of the images of the cards shown in FIGS. 5 and 7 is first prepared together with a background image. A combination of the lower part image and the background image are hereinafter referred to as the “first partial image”. As illustrated in FIG. 10, a lower part image corresponding to the lower parts of the images of the cards shown in FIGS. 6 and 8 and a background image are prepared as the first partial image.

FIGS. 9 and 10 reveal that the first partial image is rectangular and is surrounded by the upper side, the lower side, and the two lateral sides, which are visually expressed. Within the region surrounded by the four sides, the image of each lower part of the armored fighter and the female fighter illustrated in FIGS. 5 and 7 is shown in FIG. 9. Likewise, the image of each lower part of the armored fighter and the female fighter illustrated in FIGS. 6 and 8 is shown in FIG. 10.

In practice, each first partial image shown in FIGS. 9 and 10 is composed of 64 dots wide by 80 dots high, and the positions and the images of the individual dots are represented by position data and image data (hereinafter collectively referred to as “image displaying data”), respectively. The amount of the image displaying data representing the first partial image may be about half the amount of the image displaying data required for representing a single card, such as the ones shown in FIGS. 5 through 8. In practice, the image displaying data of the first partial image is stored in the card storage portion 152A by being compressed according to the joint photographic experts group (JPEG) method.

The image displaying data of the dots includes data that corresponds to the portion (indicated by B1 and B2 in FIGS. 9 and 10, respectively) to be joined with the upper part image and that will hereinafter referred to as the “first boundary data”. The first boundary data is managed separately from the other image displaying data in the following manner.

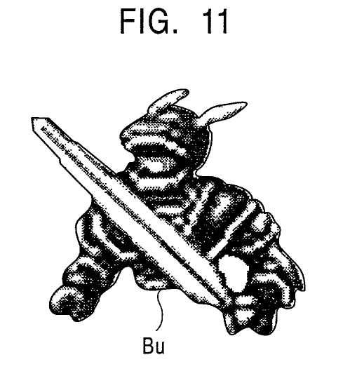

The images which represent the upper parts of the cards (shown in FIG. 5 (or FIG. 6) and FIG. 7 (or FIG. 8)) will be hereinafter referred to as “second partial image”. As readily understood from FIG. 11, only the picture portion in each second partial image is not transparent and the remaining portion is transparent in the image. Although not illustrated in FIG. 11, it is to be noted that the second partial image is surrounded by the upper side, the lateral sides, and the lower side so as to be joined with the first partial image. Specifically, the upper side and the lateral sides are not visually shown since they are transparent, and only part of the lower side is visually shown. The upper side and the lateral sides of the second partial image overlap with those of the first partial image. The lower side of the second partial image contains the boundary portion to be joined with the first partial image. The boundary portion is represented by “second boundary data”. The second boundary data contains image data and position data at the portion to be joined with the first partial image. As well as the image data of the first partial data, the image data of the second partial data is subjected to compression.

In FIG. 11, the second partial image is shown which represents the upper parts of the armored fighters shown in FIGS. 5 and 6. As is apparent from FIG. 11, the upper side and the lateral sides of the second partial image are not visually shown, and the lower side contains a joining portion Bu to be joined with the first partial image. In this manner, image (picture) data and position data (hereinafter collectively referred to as the “image displaying data”) specify the second partial image representing only the upper part of the card. In this case, the joining portion Bu to be joined with the joining portions B1 and B2 of the first partial image is represented by the second boundary data consisting of the image displaying data. The position data of the first and second boundary data is controlled so that the second boundary data coincides with the first boundary data in a manner to be described in detail below. Accordingly, as in the first boundary data, the second boundary data is separately managed. In other words, according to the card creating method used in the present invention, the position data is controlled so that the first boundary data of the first partial image coincides with the second boundary data of the second partial image. The first partial image and the second partial image can then be combined so as to create a composite image.

The amount of image displaying data required for representing the second partial image may be about half the amount of data required for representing a single card, such as each card shown in FIGS. 5 through 8.

Although, in the foregoing example, the card creating method is discussed by exemplifying the armored fighter shown in FIGS. 5 and 6, the same applies to the female fighter shown in FIGS. 7 and 8. Accordingly, in this example, four cards can be displayed from the image displaying data of two cards. This advantage becomes remarkable with an increase of the first and second partial images. For example, if first partial images of 100 and second partial images of 100 are prepared by dividing each of the 100 cards into two, cards of 10,000 can be obtained with only a memory capacity for 100 cards prepared.

Referring back to FIG. 4, the above-described point is described in detail. The card storage portion 152A used in the present invention is partitioned into a first region Hm and a second region Be for storing human-type cards indicating human-type monsters and beast-type cards indicating beast-type monsters, respectively. The first region Hm consists of a first partial portion Hm1 and a second partial portion Hm2. Likewise, the second region Be consists of a first partial portion Be1 and a second partial portion Be2.

In the first partial portion Hm1 of the first region Hm, the image displaying data representing the upper parts of the human-type cards is stored. In the second partial portion Hm2, is stored the image displaying data representing the lower parts of the human-type cards. The armored fighter cards shown in FIGS. 5 and 6 and the female fighter cards shown in FIGS. 7 and 8 belong to human-type cards. Similarly, the image displaying data of the upper parts of the beast-type cards and that of the lower parts are respectively stored in the first partial portion Be1 and the second partial portion Be2 of the second region Be.

In the example shown in FIG. 4, 70 types of upper parts of a human-type card and 70 types of lower parts of a human-type card are stored in the first partial portion Hm1 and the second partial portion Hm2, respectively. Thus, by combining the upper part images and the lower part images, 4900 types of human-type cards can be created. The 70 upper part images of a human-type card is stored in addresses HU00 through HU69 of the first partial portion Hm1 as image displaying data HMU00 through HMU69, respectively. The 70 lower part images are stored in addresses HL00 through HL69 of the second partial portion Hm2 as image displaying data HML00 through HML69, respectively.

As discussed above, the image displaying data HML00 through HML69 representing the lower part images contain not only the image data and the position data of the lower parts, but also the background data and the second boundary data of each card.

Likewise, 70 types of upper parts of a beast-type card and 70 types of lower parts of a beast-type card are respectively stored in the first partial portion Be1 and the second partial portion Be2 of the second region Be. As in the human-type card, by combining the upper part images with the lower part images of the beast-type card, 4900 types of beast-type cards can be created. The 70 upper part images are stored in addresses BU00 through BU69 of the first partial portion Be1 as image displaying data BMU00 through BMU69, respectively. The lower part images are stored in addresses BL00 through BL69 of the second partial portion Be2 as image displaying data BML00 through BML69, respectively.

In the example shown in FIG. 4, the upper part images of the human-type card stored in the first partial portion Hm1 of the first region Hm may be combined with the lower part images of the beast-type card stored in the second partial portion Be2 of the second region Be. With this type of combination, a card having an image, such as a centaur, which is an imaginary creature with the head, chest and arms of a man and the body and legs of a horse, can be created. In contrast, the upper part images of the beast-type card stored in the first partial portion Be1 of the second region Be may be combined with the lower part images of the human-type card stored in the second partial portion Hm2 of the first region Hm, thereby creating a card having an image with the head, chest and arms of a beast and the body and legs of a human.

Accordingly, in this example, 140 types of upper part images can be combined with 140 types of lower part images, thereby creating 19600 new cards.

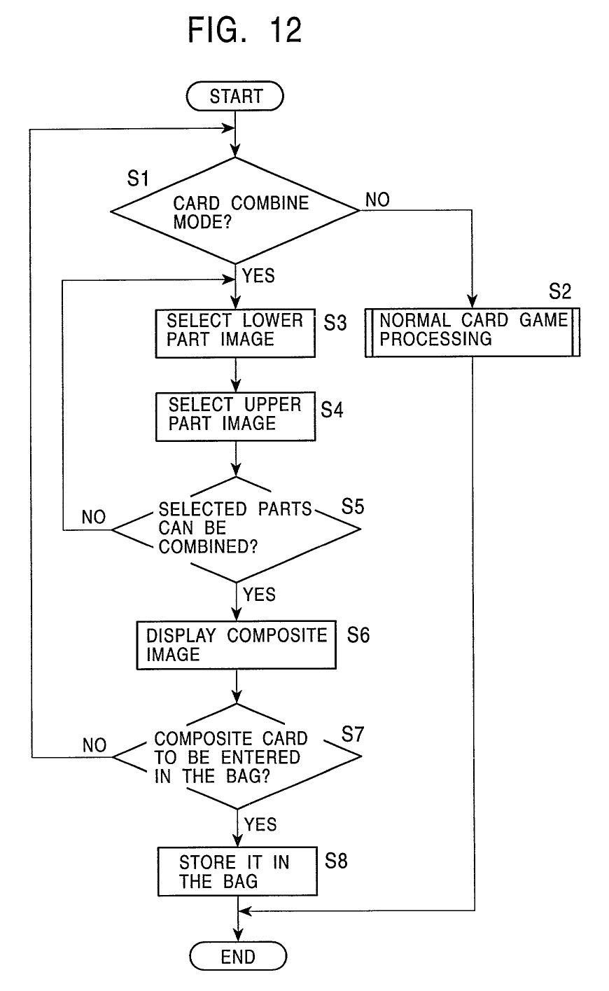

Referring to FIGS. 2 and 3 again and FIG. 12 afresh, a description is now given about the operation executed when the cassette 12 provided with the card storage portions 152A and 152B (FIG. 4) is loaded into the portable game machine 11 (FIG. 1).

When the portable game machine 11 is powered on while the cassette 12 is loaded therein, at least a part of the card game program is sent from the program storage area 151 of the cassette 12 to the portable game machine 11 and is loaded into a predetermined area of the RAM 28 of the portable game machine 11.

In this state, the following procedure is taken as disclosed in the previously filed Japanese Patent Application Nos. 11-74598 and 11-74631. Provision is made of a bag which is composed of a predetermined number of cards possessed by a player. The cards in the bag is selected by the player and is displayed to form a deck consisting of 40 cards selected by the player or the computer to be used in the game. Then, the cards in the deck are placed face down on the screen of the display panel (liquid crystal panel) 21. The cards are individually selected with a cursor from hand cards and, if necessary, they are turned over to check the content, and are then placed into the playing field.

The following features are also similar to those of the card game disclosed in the above-described applications. Predetermined life points are assigned to each of the player and an opponent, and the game is played until the life points of either the player or the opponent are reduced to zero. The player and the opponent are able to selectively designate an attack mode or a defense mode for each of the cards placed in the corresponding playing field. Thus, the player and the opponent can fight with each other in either an attack-versus-defense mode or an attack-versus-attack mode. Additionally, the following three types of cards are prepared in this card game: monster cards provided with an attacking ability index and a defending ability index, field cards for varying at least one of the attacking ability indices and the defending ability indices of the monster cards by changing the duel field, and enchantment cards which exert specific effects influencing the player's cards, the opponent's cards, the player's life points, and the opponent's life points when they are located into the playing field.

The card game itself played in the game machine of the present invention is similar to that disclosed in the previously filed applications, and therefore will not be described any longer.

However, the present invention differs from the above-described applications in that the number of cards that can be stored in the bag is remarkably increased from 300 to 720 and is therefore more than twice. Accordingly, in the present invention, card images obtained by combining the card images stored in the card storage portion 152A are stored as the image displaying data together with the addresses, in the bag of the player, i.e., in the RAM 28 shown in FIG. 3.

In transferring the image displaying data stored in the card storage portion 152A (FIG. 4) to the bag provided in the RAM 28 of the CPU 23 (FIG. 3), codes or addresses corresponding to the addresses of the card storage portion 152A are sent from the CPU core 26 to the address controller 16 shown in FIG. 2. Thus, the image displaying data is stored in the bag within the RAM 28 in response to the addresses of the card image storage portion 152A corresponding to the sent codes or the addresses. More specifically, codes or addresses corresponding to the following combinations are assigned to the card storage portion 152A: combinations of the addresses (HU00 through HU69) of Hm1 and the addresses (HL00 through HL69) of Hm2, combinations of the addresses (HU00 through HU69) of Hm1 and the addresses (BL00 through BL69) of Be2, combinations of the addresses (BU00 through BU69) of Be1 and the addresses (HL00 through HL69) of Hm2, and combinations of the addresses (BU00 through BU69) of Be1 and the addresses (BL00 through BL69) of Be2. As a result, the image displaying data is transferred to the RAM 28 in response to the corresponding two addresses of the card storage portion 152A.

When the image displaying data representing a composite image obtained from the card storage portion 152A is stored in the bag within the RAM 28, the composite image card can be used in the card game in a manner similar to normal cards.

In the game machine constructed in accordance with the present invention, a card combining mode is provided to create composite cards by a player's operation or by communications.

The operation in the card combining mode is discussed below with reference to FIG. 12. In this case, the card-image storage area 152 within the cassette 12 shown in FIG. 2 is sequentially accessed in response to the player's operation so as to display the image displaying data of each address on the liquid crystal panel 21.

More specifically, it is determined by the CPU core 26 in step S1 whether the card combining mode is selected by the operation performed on the operation panel 22 by the player. If the outcome of step S1 is no, the normal card game processing is executed in step S2. If the result of step S1 is yes, the process proceeds to step S3. In step S3, the lower part image is selected according to a player's instruction. In this case, the image displaying data representing the lower part image stored in the corresponding address from the second partial portions Hm2 through Be2 of the card storage portion 152A is selected according to the player's instruction. The selected image displaying data is transferred to the CPU core 26 via the connector 18 shown in FIG. 2, and the connector 24 and the buffer 31 shown in FIG. 3. The CPU core 26 stores the image displaying data in the display RAM 42, and then, displays it on the screen of the liquid crystal panel 21. Thereafter, by displaying all the lower part images according to a procedure similar to the above-described procedure, the player decides or sets the lower part image. Subsequently, the process proceeds to step S4 of selecting the upper part image.

Like in step S3, the addresses corresponding to the first partial portions Hm1 and Be1 of the card image storage portion 152A are sequentially accessed in step S4 in response to a player's instruction under the control of the address controller 16 (FIG. 2). Then, the image displaying data concerned with the upper part images stored in the first partial portions Hm1 and Be1 is read from the corresponding addresses and are transferred to the CPU core 26. The transferred image displaying data related to the upper part images is sent to the display RAM 42 and is displayed on the screen of the liquid crystal panel 21 via the display driving circuit 35 under the control of the CPU core 26.

When the upper part is set by the player's operation, the CPU core 26 determines in step S5 whether the lower part image selected in step S3 can be combined with the upper part image selected in step S4. In this case, the above-described second boundary data of the lower part image and the first boundary data of the upper part image are compared with each other by the CPU core 26. If the positional relationship of the two boundary data is not suitable to be combined, the process returns to step S3 in which the lower part image is selected again. Alternatively, the upper part image may be selected again. In either case, the process returns to step S4 if it is determined in step S5 that the two parts cannot be combined.

If it is found in step S5 by monitoring the boundary data of the upper part image and the lower part image that the two images can be combined, the process proceeds to step S6. In step S6, the CPU core 26 controls the display RAM 42, the RAM interface 40, and the display driving circuit 35 to display the composite card image on the screen of the liquid crystal panel 21.

Then, it is determined by the player in step S7 whether the composite card is to be added into the bag. If the player gives an instruction not to add the composite card into the bag by operating the operation panel 22, the process returns to step S1 in which a determination is made as to whether the card combining mode is selected.

If it is found in step S7 that the player has decided to add or enter the composite card into the bag, the card is entered in the bag within the RAM 28 in step S8, and is thus put in a usable state in the card game. Then, the card combining processing is completed.

After the game is over, the card data of the bag including the composite card obtained by combining the two parts, as discussed above, is stored in the RAM 17 within the cassette 12 (FIG. 2) according to the player's selection and under the control of the CPU core 26.

The foregoing description has been given for the case in which a composite card obtained by combining the upper part image and the lower part image is used in the card game. In the present invention, however, the image displaying data representing the upper part image and/or the lower part image may be sent to other players by communicating via the communication controller 50 (FIG. 3).

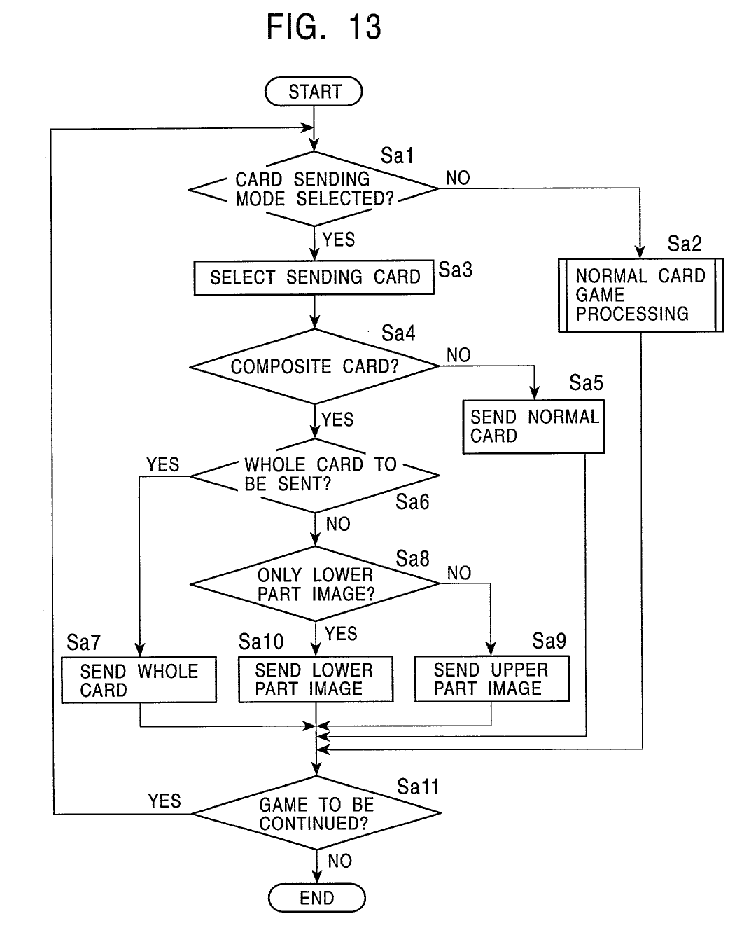

Referring to FIG. 13, a description is given below about the operation of sending or transmitting the image displaying data of a composite card on the assumption that the image displaying data of the composite card is already transferred from the card storage portion 152A to the RAM 28. It is determined in step Sa1 whether the card sending mode is to be selected by the player via the screen of the liquid crystal panel 21. If it is found in step Sa1 that the player has not selected the card sending mode, the process proceeds to step Sa2 in which normal card game processing is executed.

If it is found in step Sa1 that the player has selected the card sending mode, the process proceeds to step Sa3. In step Sa3, the liquid crystal panel 21 is switched to the sending-card selection screen, and in this state, the player selects a card to be sent. In actuality, the image displaying data indicating the cards within the bag of the RAM 28 is sequentially displayed on the liquid crystal panel 21 according to the player's operation. If a card is selected in step Sa3, the CPU core 26 determines in step Sa4 whether the selected card is a composite card.

If it is found in step Sa5 that the selected card is a normal card rather than a composite card, the normal card is sent in step Sa5. If it is determined in step Sa5 that the selected card is a composite card, it is determined in step Sa6 whether the whole composite card is to be sent, and the screen for instructing the player to make the above determination is displayed on the liquid crystal panel 21. If the outcome of step Sa6 is yes, the process proceeds to step Sa7. In step Sa7, the CPU core 26 identifies that the player has decided to send the whole composite card, and controls the communication controller 50 to send the whole composite card to another player via a communication line or infrared rays.

In contrast, if it is determined in step Sa6 that the player has decided not to send the whole composite card, the CPU core 26 determines in step Sa8 whether or not only the lower part image of the composite card is selected by the player to be sent. If the result of step Sa8 is no, the process proceeds to step Sa9. In step Sa9, the CPU core 26 determines that the upper part image is selected by the player to be sent. As a result, the upper part image is sent or transmitted in step Sa9. If it is found in step Sa8 that the player has decided to send the lower part image, the lower part image is sent in step Sa10.

When the normal card game is over in step Sa2, the process proceeds to step Sa11. The step Sa11 is also executed when the sending of the normal card is completed in step Sa5, when the sending of the whole composite card is completed in step Sa7, when the sending of the upper part image is completed in step Sa9, or when the sending of the lower part image is completed in step Sa10.

In step Sa11, display is made on the liquid crystal panel 21 so as to make the player determine whether or not the card game is to be continued. If the player decides not to continue the card game, the game is over. If the player decides to continue the card game, the process returns to step Sa1 in which the display screen is switched to the card sending mode screen.

As described above, according to the present invention, the whole composite card can be sent and exchanged with another player. Alternatively, only part of the composite card can be sent and exchanged with another player. The composite card may be sent to another player from the loser to the winner after the game, or composite cards may be exchanged between players when predetermined conditions are satisfied.

When the communication controller 50 shown in FIG. 3 is used as a transmitting side for sending the whole card or part of the card, it is operated as a card sending unit under the control of the CPU core 26. On the other hand, when the communication controller 50 is used as a receiving side for receiving the whole card or part of the card from the other player, it is operated as a card receiving unit.

In the foregoing embodiment, a single card is divided into two parts, i.e., the upper and lower parts. However, a card may be divided at any position. A card may also be divided into three or four parts, and the divided part images may be combined to create a new card. In this case, if each card is divided into n parts (n is a positive integer), Nⁿ cards can be created (N is indicative of the number of cards to be divided and is a positive integer). Meanwhile, since the memory capacity for storing divided images increases at the ratio of (n, many cards can be stored in a small memory capacity. In this manner, when each card is divided into three or more partial images, only part of the partial images can be exchanged between players via the communication controller 50 so as to create different types of cards unique to each player.

As stated above, when a single card is created by combining divided part images, the attacking ability index and the defending ability index of the created card vary according to the field. In addition, however, the created card may also be classified into some groups and families, and some groups and families may be superior to the other groups and families. In this case, the groups and the families are also stored in the table 153C shown in FIG. 4.

It is necessary, however, to consider that the storage capacity of the table 153C may increase with an increased number of composite cards if the data, such as the groups and families, concerning the composite cards is also stored in the table 153C.

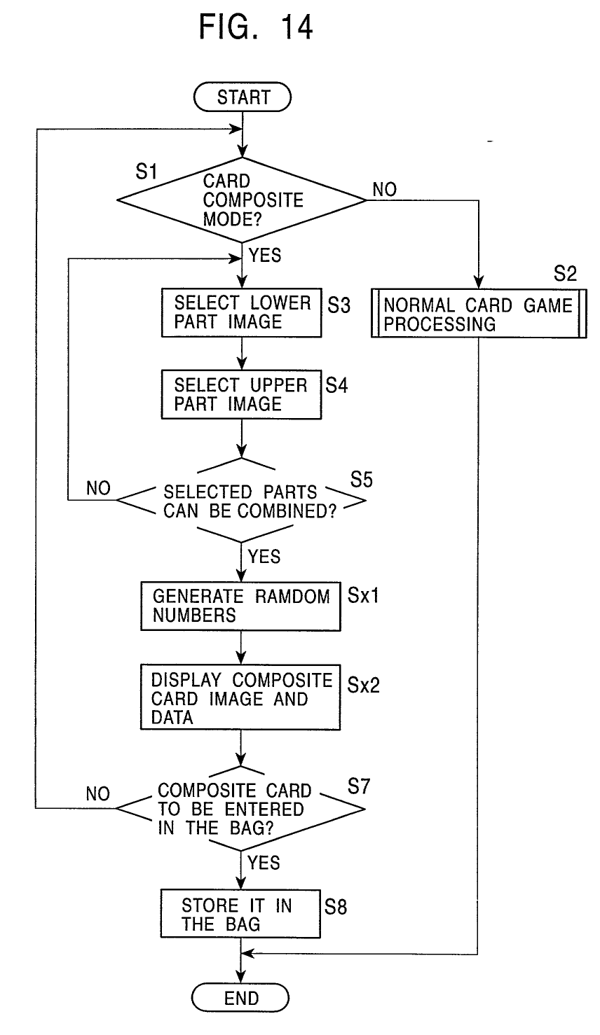

A game machine constructed in accordance with another embodiment of the present invention is described below with reference to FIG. 14. In the game machine of this embodiment, even with an increased number of composite cards, the storage capacity of the game machine does not exceed the capacity allowed for the portable game machine. As stated above, when 19600 new composite cards are created by combining part images, as in the example shown in FIG. 4, it is necessary to store the attacking ability indices and the defending ability indices of the new cards. Additionally, the attacking ability index and the defending ability index of each card vary according to the duel field. In this event, storage should also be made about the attacking ability indices and the defending ability indices of the new cards which are varied in each of the fields. As stated above, since the composite cards used in the card game are classified into some groups and families, the data concerning the groups and the families should also be stored. However, storing such various items of data concerning 19600 composite cards undesirably brings about an increase of the data amount in the table 153C of the portable game machine 11 which only has a limited memory capacity.

Accordingly, to solve this problem, another card creating method is shown in FIG. 14. In this method, the number of composite cards can be increased without increasing the storage capacity of the portable game machine. The card creating method shown in FIG. 14 is similar to that shown in FIG. 12, except for the processing which is executed after decision in step S5 is made about whether or not the upper and lower part images can be combined. The other steps of FIG. 14 are similar to those of FIG. 12, and thus, only the above-described processing is discussed in detail below.

If it is judged in step S5 that the selected parts can be combined, random numbers corresponding to a composite card can be generated in step Sx1 in a manner to be discussed in detail below. In step Sx1, M-sequence random numbers are assumed to be generated on the basis of the random number seed corresponding to each composite card, and each card is specified by a unique random number sequence. In this example, the random number seed is determined by calculating the sum of the number assigned to the lower part image and the number assigned to the upper part image and by multiplying the sum by a predetermined coefficient.

The random number sequence determined from the random number seed has a predetermined long cycle of, for example, 2³²−1. The generation order of the random numbers is defined in each random number sequence. The individual random numbers in each random number sequence is made to correspond to the attacking ability index and the defending ability index in each field and also to correspond to the group and the family. In step Sx1, computations are performed on the basis of the random numbers in each random number sequence according to the order, so as to thereby determine the corresponding ability indices, group, and family.

Subsequently, in step Sx2, the composite card image and the results obtained by computing the random numbers are displayed on the liquid crystal panel 21, and thereafter, processing is executed in a manner similar to that discussed with reference to FIG. 12.

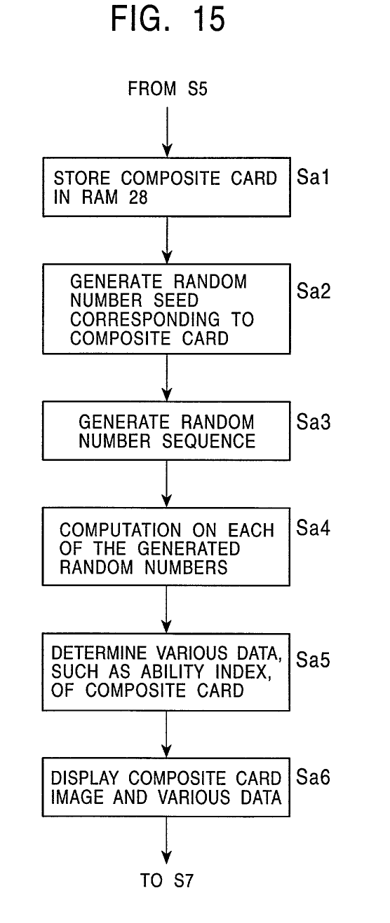

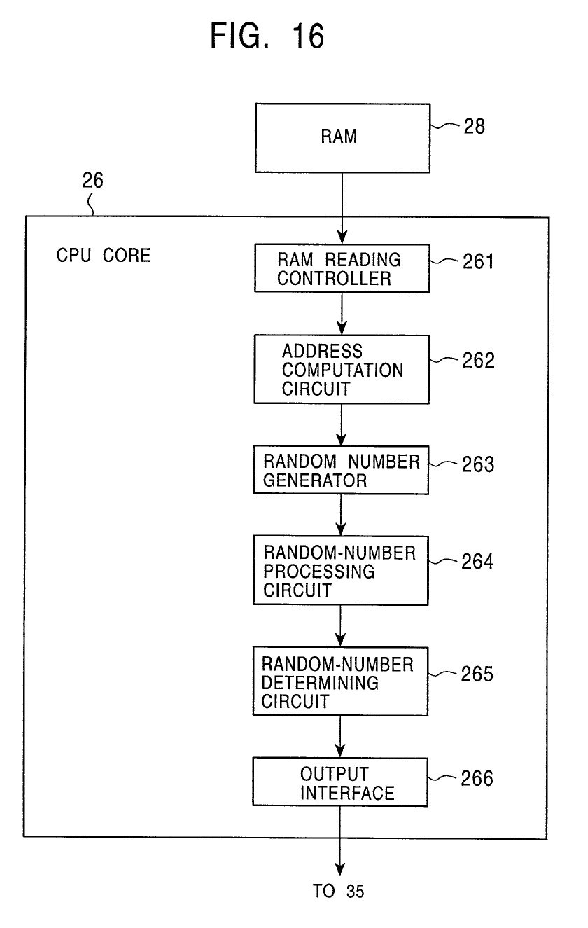

Referring to FIGS. 15 and 16, description will be made in detail about the random-number generating processing in step Sx1 of FIG. 14 and about the operation of the CPU core 26. In step Sa1 of FIG. 15, the composite card is first stored in the RAM 28 shown in FIG. 3 and read out of the RAM 28. In this case, the composite card is stored at the addresses of the RAM 28 corresponding to the numbers assigned to the lower part image and the upper part image forming the composite card.

In this state, in step Sa2, the CPU core 26 generates the random number seed corresponding to the composite card. More specifically, addresses in the storage locations of the lower part image and the upper part image forming the composite card are generated under the control of a RAM reading controller 261 (FIG. 16) of the CPU core 26. Herein, it is presumed that the lower part image is stored at the 50th address of the lower part image area of the RAM 28 and the upper part image is stored at the 50th address of the upper part image area of the RAM 28. When the addresses “50” and “50” are generated by the RAM reading controller 261 and are sent to an address computation circuit 262 (FIG. 16), the address computation circuit 262 adds the two addresses obtained from the RAM reading controller 261 and multiplies the sum by a predetermined coefficient, for example, 100. Thus, the random number seed is determined by the address computation circuit 262.

When the random number seed is generated in step Sa2, as discussed above, the CPU core 26 generates the random number sequence corresponding to the random number seed in step Sa3. More specifically, the random number seed calculated in the address computation circuit 262 is supplied to a random number generator 263, which then generates a random number sequence (, that is, the M-sequence random number sequence, in this example) by using the random number seed as the initial value. It is now assumed that twelve random numbers, such as 5, 5, 3, 2, 1, 4, and so on, are sequentially generated. In this case, the first random number is assigned to the attacking ability index of the composite card in the normal field, and the second random number is assigned to the defending ability index of the composite card in the normal field. Thereafter, similarly, the third and fourth random numbers are allocated to the attacking ability index and the defending ability index, respectively, in the forest field, and the fifth and sixth random numbers are allocated to the attacking ability index and the defending ability index, respectively, in the wilderness field.

Then, in step Sa4 of FIG. 15, computation is performed on each of the random numbers forming the random number sequence according to the order of the random numbers. To perform this computation, a random-number processing circuit 264 is provided for the CPU core 26. The random-number processing circuit 264 identifies the order of the random numbers and performs computation according to the order. For example, the first random number is multiplied with a coefficient, 100, the second random number is multiplied with a coefficient, 120, and so on. Accordingly, in step Sa5, the ability indices in each field and the group and the family are determined for the composite card. To determine such data, a random-number determining circuit 265 is provided for determining the processing result. In step Sa6, the determination result of the random-number determining circuit 265 is displayed, together with the composite card image, as various data concerning the composite card on the liquid crystal panel 21 via an output interface 266.

Subsequently, it is determined in step S7 of FIG. 14 whether the composite card is to be entered in the bag according to the player's operation. Thereafter, the operation is performed in a manner similar to that shown in FIG. 12.

As discussed above, every time a composite card is selected, the above-described operation is repeated so as to determine data required for the composite cards by computation. As a result, a large amount of data for the composite cards may not be stored in a memory and thereby the storage capacity for storing the composite cards can be significantly reduced.

In the foregoing embodiment, the CPU core 26 computes the ability indices, the family and the group from the random numbers. However, in the present invention, the level of each card may be determined by dividing the sum of the attacking ability index and the defending ability index of each card with a predetermined value. In this case, for example, the sum of the attacking ability index and the defending ability index may be divided with a predetermined value, 100, and the resulting remainder may determine the level of the card. As for providing the level for each card, the card game may also be graded, thereby restricting the level of the card usable in the card game. This serves to prevent the player's interest from being directed only to use and collection of the cards which have high attacking and defending ability indices.

Although in the foregoing embodiment only data concerning composite cards is determined by using random numbers, data concerning normal cards may also be determined by using random numbers.

In the foregoing embodiments, the card game is performed by using the portable game machine 11 shown in FIG. 1. However, the present invention may also be used in commercial game machines, home-use game machines operated by using television sets, personal computers executing the card game, etc.

As is seen from the foregoing description, the present invention offers the following advantages. The number of cards can be remarkably increased with a small memory capacity, and various types of cards which the player does not intend to create can be implemented by combinations of partial images. The cards can be partially exchanged, and the players are able to enjoy not only the card game, but also enjoy collecting the cards, thereby making it possible to keep the players' interest. In sending and receiving part of the cards, the received partial cards can be used to combine with other partial cards to create new cards. Additionally, the card-related data, such as the attacking and defending ability indices, of various composite cards, is determined by computations rather than being stored in the table. This enables to considerably reduce the storage capacity required for the card-related data.

What is claimed is:

1. A game machine for performing a card game by displaying a plurality of cards on a screen of a display device, comprising:
storage means for storing partial images obtained by dividing an image of each of the plurality of cards used in said card game; and
combining means for combining the partial images so as to create a composite card having an image different from the images of the plurality of cards.

2. A game machine according to claim 1, wherein the partial images are obtained by dividing each of the cards into an upper part image and a lower part image, and said storage means comprises a first partial storage portion for storing the upper part image and a second partial storage portion for storing the lower part image.

3. A game machine according to claim 2, wherein one of said first partial storage portion and said second partial storage portion stores, as the partial image, not only image data representing a picture of one of the upper part image and the lower part image, but also background image data of each of the cards and the other partial storage portion stores image data representing a picture of the corresponding other part image as the partial image.

4. A game machine according to claim 3, wherein, in the partial storage portion without the background image data, the partial image other than the picture is transparent.

5. A game machine according to claim 1, wherein said storage means stores boundary data representing a joining portion of one of the partial images to be joined with the other partial image, and said combining means combines the partial images by referring to the boundary data of the partial images.

6. A game machine according to claim 1, further comprising sending means for selectively sending the partial images and the composite card.

7. A game machine according to claim 1, further comprising receiving means for receiving the partial images, wherein said combining means combines the partial images received by said receiving means to create a composite card and exchanges the composite card with another player.

8. A game machine according to claim 2, wherein the image of each of the cards is further divided into more than two partial images.

9. An image display method for use in a game machine for performing a card game and for displaying a plurality of cards used in said card game on a screen of a display device, said image display method comprising:
a storage step of storing partial images obtained by dividing an image of each of the plurality of cards;
a combining step of combining the partial images so as to create a composite card having an image different from the images of the plurality of cards; and
a display step of displaying the composite card on said display device,
wherein said storage step also stores boundary data of each of the partial images, and said combining step comprises the steps of:
preparing a picture image and a background image as one of the partial images;
preparing only a picture image as the other one of the partial images, with the remaining image kept transparent in the other partial image; and
combining the partial images by referring to the boundary data, so that a greater number of cards is displayed than the number of cards before being divided.

10. A computer-readable recording medium for storing a program executing a card game by displaying cards of a player and an opponent on a screen of a display device, said program comprising:
a reading step of reading stored partial images obtained by dividing an image of each of the cards; and
a combining step of combining the partial images read in said reading step so as to create a composite card having an image different from the images of the cards.

11. A game machine according to claim 1, wherein said storage means stores a table in which an attacking ability index and a defending ability index corresponding to the composite card are stored.

12. A game machine according to claim 1, further comprising computation means for computing an attacking ability index and a defending ability index corresponding to the composite card according to data uniquely assigned to the composite card.

13. A game machine according to claim 12, wherein said computation means comprises means for determining a random number seed as the data uniquely assigned to the composite card, means for generating a random number sequence from the random number seed, and means for calculating the attacking ability index and the defending ability index of the composite card from the random number sequence.

14. A game machine for performing a card game by displaying cards on a screen of a display device, comprising:
storage means for storing images of the cards used in said card game; and
computation means for computing data related to the cards other than the images of the cards by using data unique to the cards.

15. A game machine according to claim 14, wherein said computation means comprises means for determining a random number seed assigned to each of the cards as the data unique to each of the cards, means for generating a random number sequence from the random number seed, and means for calculating the card-related data from the random number sequence.

16. A computer-readable recording medium for storing a program executing a card game by displaying cards of a player and an opponent on a screen of a display device, said program comprising:
a reading step of reading images of the cards used in said card game; and
a computing step of computing data related to each of the cards by using data unique to each of the card.

17. A computer-readable recording medium for storing a program executing a card game by displaying a plurality of cards of a player and an opponent on a screen of a display device, said program comprising:
a reading step of reading stored partial images obtained by dividing an image of each of the plurality of cards;
a combining step of combining the partial images read in said reading step so as to create a composite card having an image different from the images of the plurality of cards; and
a computing step of computing data related to the composite card created in said combining step.

18. A computer-readable recording medium according to claim 17, wherein said computing step comprises a step of determining a random number seed assigned to the composite card as data unique to the composite card, a step of generating a random number sequence from the random number seed, and a step of computing the data related to the composite card from the random number sequence.
